(19) United States
(12) Patent Application Publication
(10) Pub. No.: US 2015/0101764 A1
(43) Pub. Date: Apr. 16, 2015

(54) WINDOW COVERING

(71) Applicant: Li-Ming CHENG, Kaohsiung City (TW)

(72) Inventor: Li-Ming CHENG, Kaohsiung City (TW)

(21) Appl. No.: 14/168,768

(22) Filed: Jan. 30, 2014

(30) Foreign Application Priority Data
Oct. 15, 2013 (CN) 201320635739.0

(51) Int. Cl. E06B 9/66; E06B 9/64; E06B 9/44

(52) U.S. Cl. CPC E06B 9/66; E06B 9/44; E06B 9/64
USPC 160/244; 160/340

(57) ABSTRACT

A window covering comprises an upper rail, a window shade located below the upper rail, a lower rail located below the window shade, a first press assembly and a second press assembly located at two sides of the lower rail and spaced from each other, and a cord winding assembly located in the lower rail to connect to the first press assembly and second press assembly. A first cord and a second cord run through two opposite sides of the window shade to fasten to the cord winding assembly. The lower rail can be moved upwards or downwards by a user to retract or expand the window shade through the first and second cords. Beside, the distal ends of the first and second cords can be hid in the cord winding assembly in the lower rail, thus can prevent the cords from entangling children and avoid accidents.

### FIELD OF THE INVENTION

The present invention relates to a window covering and particularly to a window covering with concealed cords.

### BACKGROUND OF THE INVENTION

There are numerous types of window coverings available on the market, such as Venetian blinds, pleated window shades, Roman shades and the like. They are mainly installed on doors and windows of houses to meet different consumers' requirements such as blocking sunshine and providing decoration function.

The general window covering has cords that can be lifted upwards and downwards to control retraction and extension thereof. For instance, U.S. Pat. No. 7,373,965 discloses a window covering 10 that mainly comprises a seat 11, a control switch 12 and a cord assembly 13, as shown in FIGS. 1 and 2. The cord assembly 13 has cords 131 converged to run through a bottom hole of the seat 11, an aperture on an anchor member of the control switch 12, and an opening of a depressing member 121 of the control switch 12, so that a lower end of each cord 131 are converged below the seat 11 and movements of the cords 131 can be controlled by the control switch 12. During retraction of the window covering 10 a user has to press the depressing member 121 of the control switch 12 with one hand and pull the lower end of each cord 131 with another hand to finish retraction of the window covering 10 (referring to FIG. 3). However, after retraction a lengthy portion of the cords 131 are exposed without a winding or concealing design. They could easily become a playing object of children and result in the risk of strangling the children.

### SUMMARY OF THE INVENTION

The primary object of the present invention is to solve the problem of conventional window coverings with exposed cords that could result in environmental safety concern to children by providing a window covering with cords wound and held in a lower rail.

To achieve the foregoing object the invention provides a window covering which comprises an upper rail, a window shade located below the upper rail and including a first cord and a second cord, a lower rail located below the window shade, a first press assembly and a second press assembly located at two sides in the lower rail and spaced from each other, and a cord winding assembly located in the lower rail has and including one side connected to the first press assembly and another side connected to the second press assembly. The first and second cords have respectively a first end threading through and fastened to a lower end of the upper rail, and a second end threading through the window shade, the interior of the lower rail, and the first and second press assemblies to fasten to the cord winding assembly.

The invention, by means of the construction set forth above, compared with the conventional techniques, provides many advantages, notably:

Through the first cord and second cord threading through the upper rail, window shade and interior of the lower rail to connect to the cord winding assembly, they are held and concealed inside the cord winding assembly in the lower rail during retraction of the window shade, hence the hazardous incident resulted from the cords entangling the children can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional window covering.

FIG. 2 is a side view of the window covering of FIG. 1.

FIG. 3 is a schematic view of the window covering of FIG. 1 in a retracted condition with the control switch pressed.

FIG. 4 is a perspective view of the invention in an extended condition.

FIG. 5 is an exploded view of the invention showing that the cord winding assembly and first and second press assembly are held in the lower rail.

FIG. 6 is a front view of the cord winding assembly and first and second press assembly of the invention.

FIG. 7 is an exploded view of the cord winding assembly and first and second press assembly of the invention.

FIG. 8 is a perspective view of the cord winding assembly and first and second press assembly of the invention with the first and second cords threading through thereof.

FIG. 9A is a schematic top view of the sealing lid of the cord winding assembly before wedging in the body according to the invention.

FIG. 9B is a schematic top view of the sealing lid of the cord winding assembly after wedging in the body according to the invention.

FIG. 10A is a schematic front view of the second press assembly before with the second press member moved in the second sleeve according to the invention.

FIG. 10B is a schematic front view of the second press assembly before the second press member swiveled in the second sleeve according to the invention.

FIG. 10C is a schematic front view of the second press assembly after the second press member anchored in the second sleeve according to the invention.

FIG. 11 is a side view of the invention showing movements of the second press assembly.

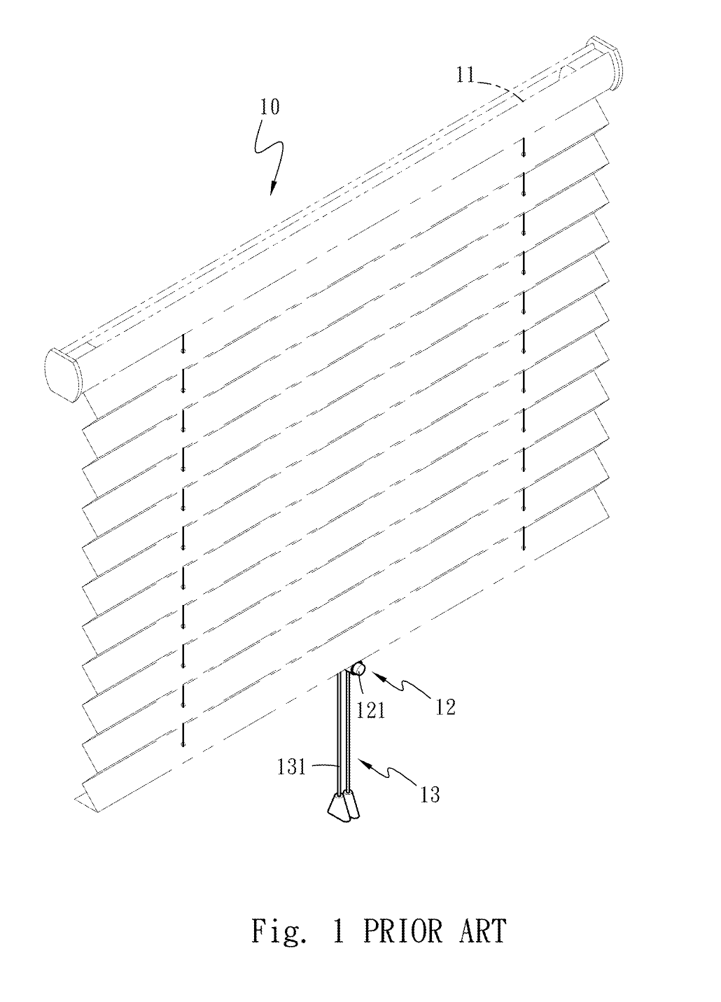

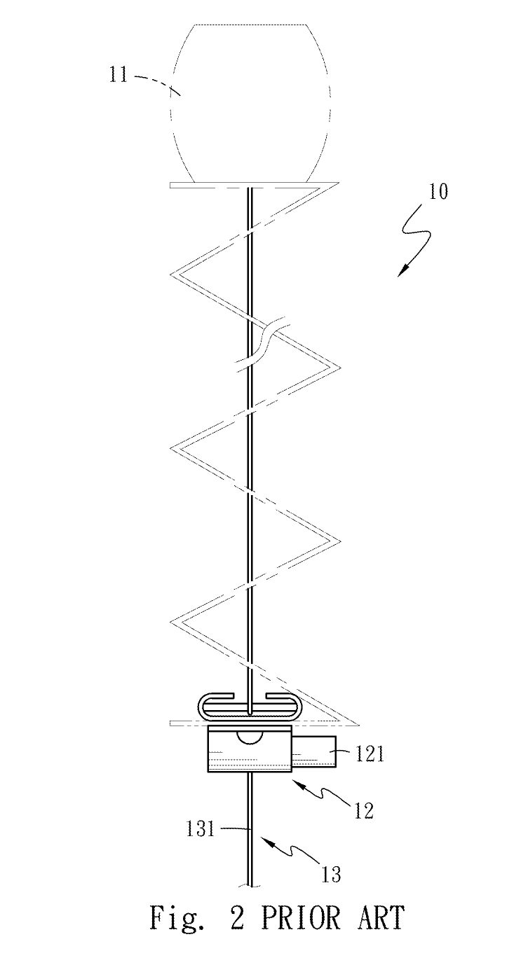

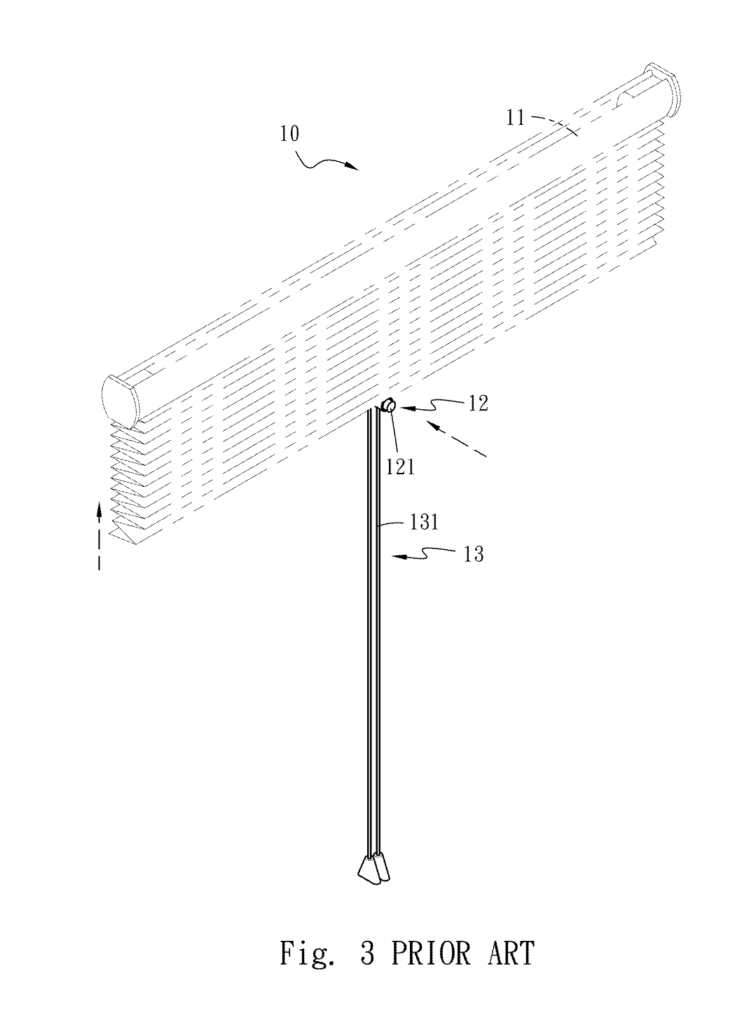

### DETAILED DESCRIPTION OF THE PREFERRED EMBODIMENT

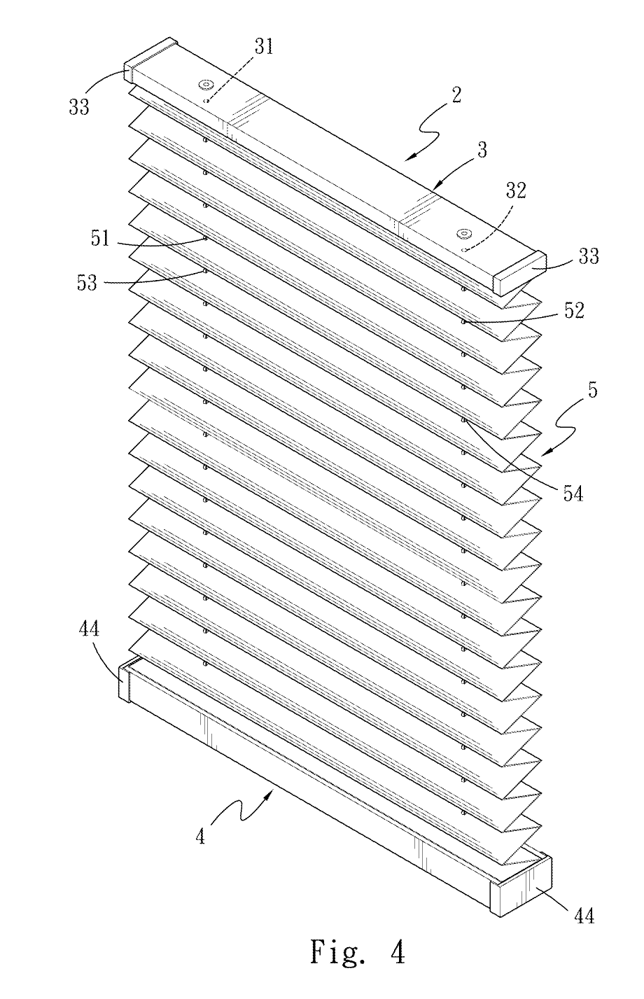

Please referring to FIGS. 4, 5 and 6, the present invention aims to provide a window covering 2 that comprises an upper rail 3, a lower rail 4 located below and spaced from the upper rail 3, a foldable window shade 5 located between the upper rail 3 and lower rail 4, and a cord winding assembly 6 which has two opposite sides respectively connected to a first press assembly 7 and a second press assembly 8.

The upper rail 3 includes a first threading hole 31 and a second threading hole 32, and two sides thereof are respectively closed by wedging with a first sealing cap 33.

The lower rail 4 includes an elongate rail holder 40 with a holding trough 41 formed therein, and a third threading hole 42 and a fourth threading hole 43 respectively corresponding to the first and second threading holes 31 and 32, and two sides thereof are respectively wedged by a second sealing cap 44 for closing thereof.

The foldable window shade 5 includes a first cord 51 and a second cord 52, and a plurality of first through holes 53 and second through holes 54 threaded through respectively by the first and second cords 51 and 52. The first cord 51 and second cord 52 have respectively a first end 511 and 521 respectively thread through the first and second threading holes 31 and 32 to fasten on the interior of the upper rail 3, and a second end 512 and 522 respectively thread through the first and second through holes 53 and 54 of the window shade 5 and the third and fourth threading holes 42 and 43 of the lower rail 4.

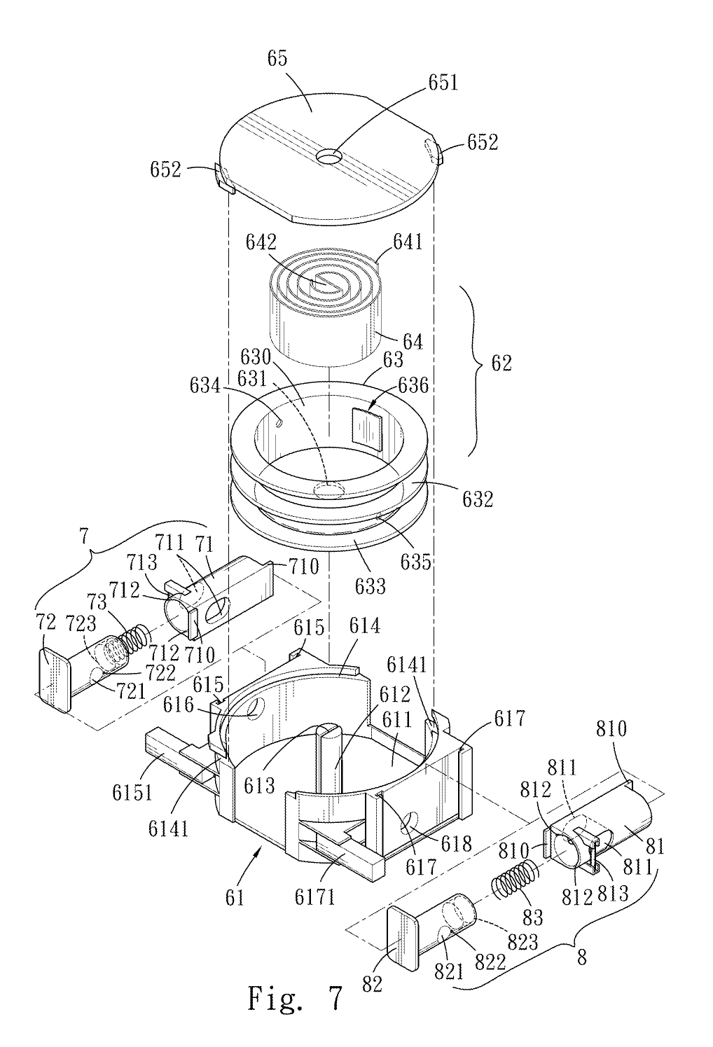

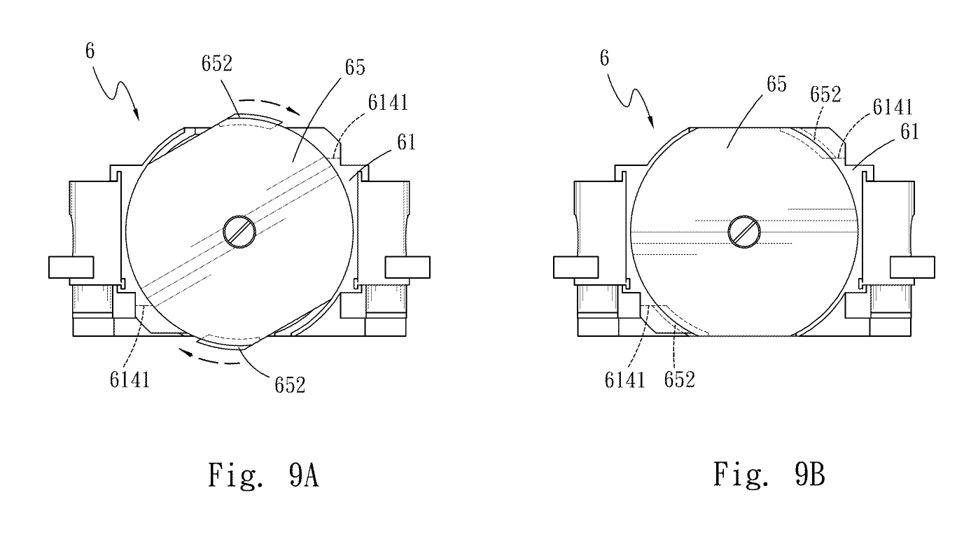

The cord winding assembly 6, referring to FIGS. 7 through 9B, which is located in the lower rail 4 and connected to the second ends 512 and 522 of the first and second cords 51 and 52, and includes a body 61 and a pulley set 62. The body 61 includes a first housing 611, a holding strut 612 disposed in the first housing 611 and including a slot 613, an indented rim 614 formed on an upper portion of the first housing 611 has and including two wedge notches 6141 at each end of a diagonal location, and a sealing lid 65 wedged in the indented rim 614. The sealing lid 65 includes a first insertion hole 651 corresponding to the holding strut 612 and two wedge members 652 formed at a diagonal location of the bottom thereof to correspondingly wedge in the wedge notches 6141 so as to fasten the sealing lid 65 on the intended rim 614 (referring to FIGS. 9A and 9B). The body 61 further has a first recess portion 615 on one lateral side thereof, a first detent member 6151 extended outwards from a front end of the body 61, a first hole 616 on the lateral side of the body 61 to communicate with the first housing 611 and first recess portion 615, a second recess portion 617 on another lateral side of the body 61 and forming at an elevation lower than that of the first recess portion 615, a second detent member 6171 extended outwards from the front end of the body 61 and opposite to the first detent member 6151, and a second hole 618 formed on the another lateral side of the body 61 to communicate with the first housing 611 and the second recess portion 617 and at an elevation lower than the first hole 616.

The pulley set 62 includes a winding spool 63 and a coil spring 64. The winding spool 63 includes a holding space 630 in the center thereof, a second insertion hole 631 at the bottom thereof run through by the holding strut 612 of the body 61, and an upper holding trough 632 and a lower holding trough 633 formed on the periphery thereof. The holding space 630 has a third hole 634 and a fourth hole 635 respectively formed at two opposite sides of an inner wall thereof and corresponding to the first hole 616 and second hole 618 of the body 61 to respectively communicate with the upper holding trough 632 and the lower holding trough 633. The coil spring 64 located in the holding space 630 and including one end 641 latched on a latch slot 636 formed on the inner wall of the winding spool 63 and another end 642 latched in the slot 613 of the holding strut 612;

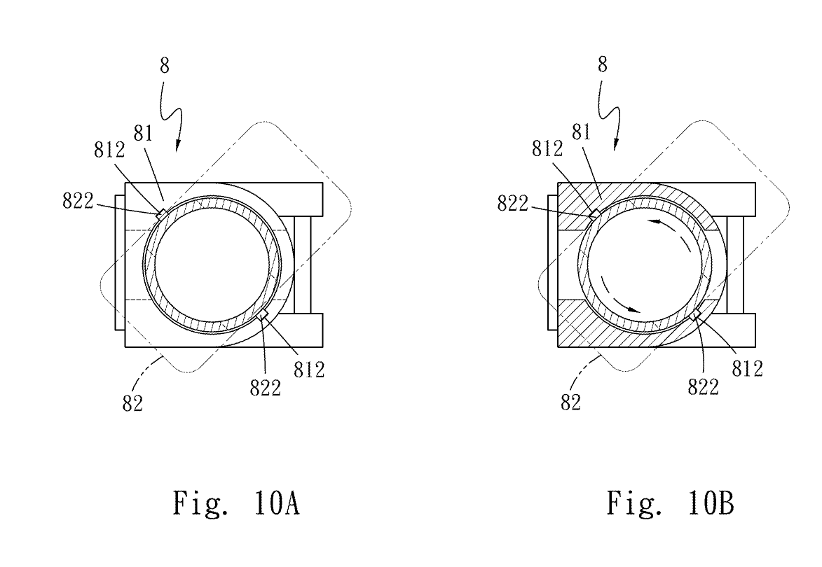

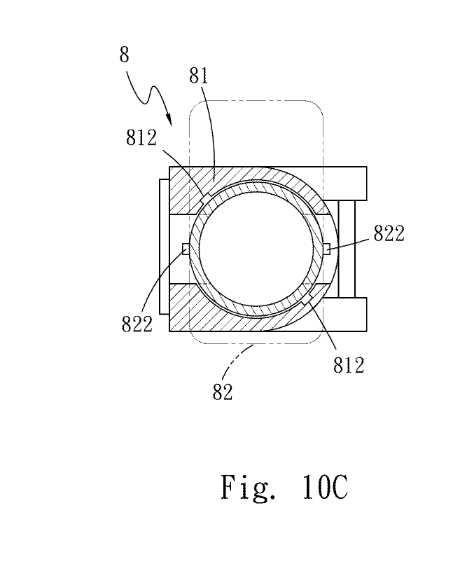

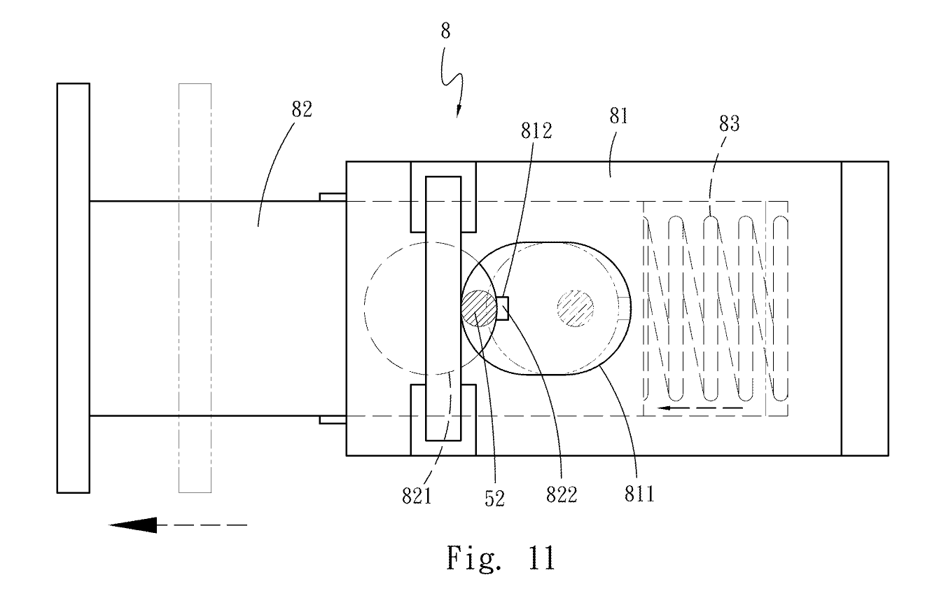

The first press assembly 7 and the second press assembly 8, please also referring to FIGS. 9A through 11, are connected to two sides of the cord winding assembly 6 and respectively positioned at a higher and a lower elevations corresponding to the first hole 616 and second hole 618 of the body 61. The first press assembly 7 includes a first sleeve 71 which includes a first wedge flange 710 at one side thereof to wedge in the first recess portion 615 of the body 61, two first apertures 711 on two sides thereof corresponding to the first hole 616, two corresponding first ditches 712 on an inner rim thereof, and a first guide bar 713 extended from an outer side of the first sleeve 71 and adjacent to the first aperture 711 to guide the second end 512 of the first cord 51. The first sleeve 71 has a hollow interior to hold and couple to a movable first press member 72. The first press member 72 includes an outer end abutting the first detent member 6151, two first bores 721 on two sides thereof corresponding to the first apertures 711, and two first bosses 722 protruded from the two sides thereof and corresponding to the first ditches 712, so that the first bosses 722 are movable in the first ditches 712 and can be latched therein to prevent the first press member 72 from separating after assembly. A first elastic element 73 is disposed between the first sleeve 71 and a first recess 723 of the first press member 72 to allow the first press member 72 to be pressed or released. The second press assembly 8 includes a second sleeve 81 that includes a second wedge flange 810 at one side thereof to wedge in the second recess portion 617 of the body 61, two second apertures 811 on two sides thereof corresponding to the second hole 618, two corresponding second ditches 812 on an inner rim thereof, and a second guide bar 813 extended from an outer side of the second sleeve 81 and adjacent to the second aperture 811 to guide the second end 522 of the second cord 52. The second sleeve 81 has a hollow interior to hold and couple to a movable second press member 82. The second press member 82 includes an outer end abutting the second detent member 6171, two second bores 821 on two sides thereof corresponding to the second apertures 811, and two second bosses 822 protruded from the two sides thereof and corresponding to the second ditches 812, so that the second bosses 822 are movable in the second ditches 812 and can be latched therein to prevent the second press member 82 from separating after assembly (referring to FIGS. 10A through 10C). A second elastic element 83 is disposed between the second sleeve 81 and a second recess 823 of the second press member 82 to allow the second press member 82 to be pressed or released (as shown in FIG. 11). The first and second elastic elements 73 and 83 can be springs or other elastic and extensible materials, thereby when the first and second press members 72 and 82 are pressed, they can be movable and extensible in the first and second sleeves 71 and 81, meanwhile to release or brake the first cord 51 and second cord 52.

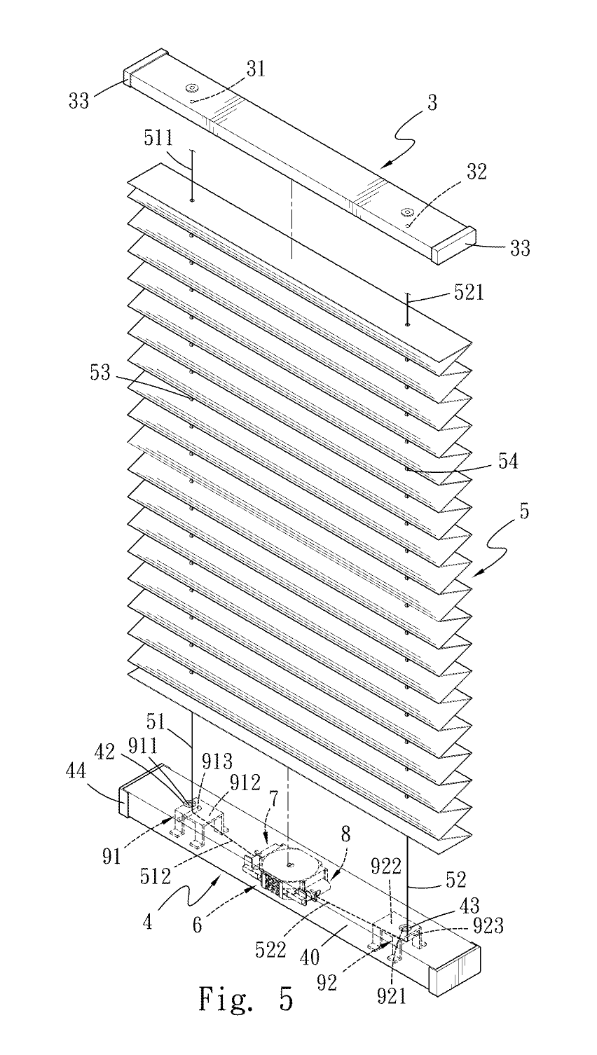

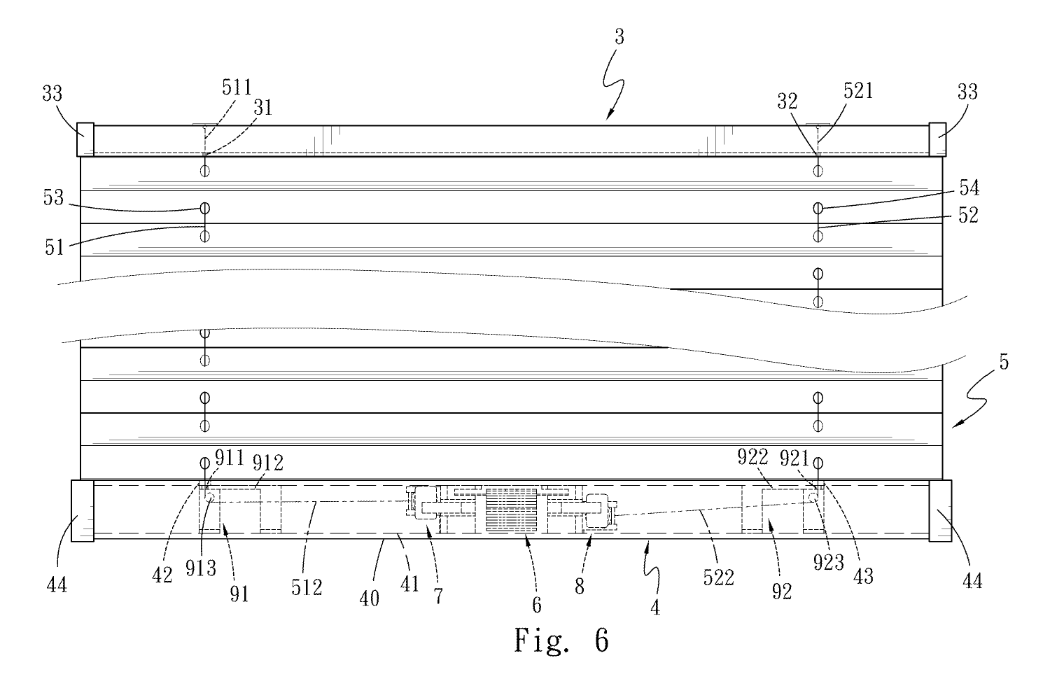

The window covering 2 further includes a first roller assembly 91 and a second roller assembly 92 that are fixedly located inside the elongate rail holder 40 of the lower rail 4 and positioned at two sides of the cord retraction assembly 6 in a symmetrical manner. Please referring to FIGS. 5 and 6, the first and second roller assemblies 91 and 92 includes respectively a first bracing seat 912 and a second bracing seat 922, a first opening 911 and second opening 921 formed on a top surface of the first bracing seat 912 and the second bracing seat 922 corresponding to the third threading hole 42 and fourth threading hole 43, and a first guide rod 913 and a second guide rod 923 at one side of the first and second bracing seats 912 and 922 and adjacent to the first and second openings 911 and 921 to allow the first and second cords 51 and 52 to wind around the first and second guide rods 913 and 923 to facilitate stretching.

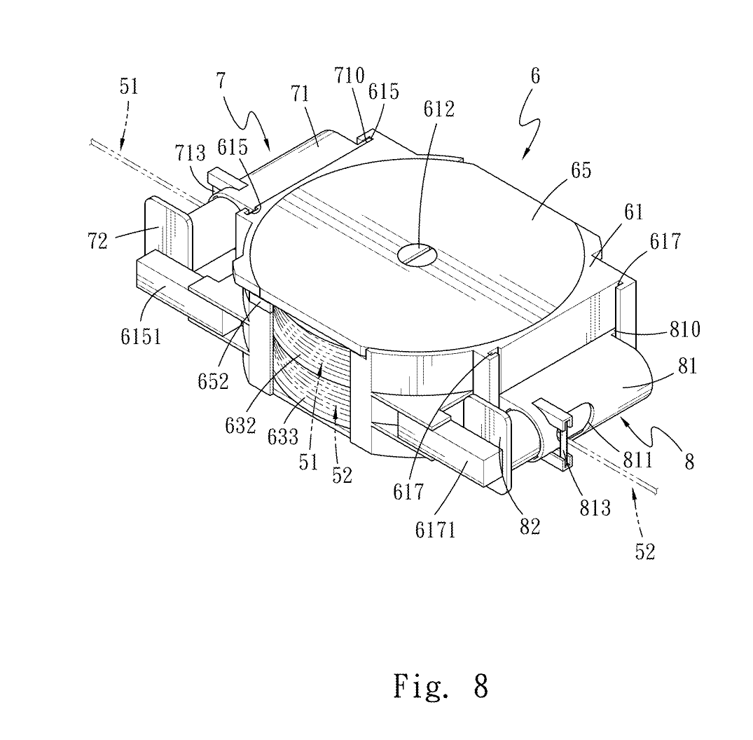

After the two second ends 512 and 522 of the first and second cords 51 and 52 have respectively threaded through the third threading hole 42 and the fourth threading hole 43, referring to FIGS. 6 and 7, they can wind on respectively the first and second guide rods 913 and 923 of the first and second roller assemblies 91 and 92, and pass through respectively the first and second apertures 711 and 811 of the first and second sleeves 71 and 81, and the first and second bores 721 and 821 of the first and second press member 72 and 82. Then the two second ends 512 and 522 of the first and second cords 51 and 52 pass through respectively the first hole 616 and the second hole 618 of the body 61, and finally thread through and wind on the upper and lower holding troughs 632 and 633 of the winding spool 63 and fasten thereon (referring to FIG. 8).

When retracting or extending the window covering 2 is desired, user can pull the lower rail 4 downwards, hence the first and second cords 51 and 52 are movable and can be stretched to turn the upper and lower holding troughs 632 and 633 of the winding spool 63 held in the body 61, and also tighten the coil spring 64 latched in the latch slot 636 of the winding spool 63 and the slot 613 of the holding strut 612. When the window shade 5 is extended to a length required, it is released and anchored. Meanwhile, as shown in FIG. 11, the first press member 72 and second press member 82 are moved to their original positions due to the elastic forces of the first elastic element 73 and second elastic element 83. Then the first cord 51 is clamped and held by the corresponding inner rims of the first apertures 711 of the first sleeve 71 and first bores 721 of the first press member 72. Similarly, the second cord 52 is clamped and held by and the corresponding inner rims of the second apertures 811 of the second sleeve 81 and second bores 821 of the second press member 82. Thus, the first and second cords 51 and 52 can be clamped and anchored to restrict their movement. Therefore, when the lower rail 4 is pushed upwards or moving downwards by the user, the first and second cords 51 and 52 can make the window shade 5 retracting upward or extending downward (also referring to FIG. 6). Moreover, the first and second cords 51 and 52 are held in the cord winding assembly 6 and concealed in the lower rail 4 without exposing, thus the hazardous accident caused by entangling the children can be avoided, and the window shade also can block sunshine or serve as an ornamental.

What is claimed is:

1. A window covering, comprising:
an upper rail;
a window shade which is located below the upper rail and includes a first cord and a second cord;
a lower rail located below the window shade;
a first press assembly and a second press assembly located at two sides in the lower rail and spaced from each other; and
a cord winding assembly which is located in the lower rail and includes one side connected to the first press assembly and another side connected to the second press assembly;
wherein the first cord and the second cord include respectively a first end threading through and fastened to a lower end of the upper rail, and a second end threading through the window shade, the interior of the lower rail, and the first press assembly and the second press assembly to fasten to the cord winding assembly.

2. The window covering of claim 1, wherein the cord winding assembly includes a body and a pulley set, wherein:
the body includes a first housing, a holding strut disposed in the first housing and including a slot, an indented rim formed on an upper portion of the first housing, a sealing lid wedged in the indented rim and including a first insertion hole corresponding to the holding strut, a first recess portion on one lateral side of the body, a first detent member extended outwards from a front end of the body, a first hole formed on the lateral side of the body to communicate with the first housing and the first recess portion, a second recess portion on another lateral side of the body and formed at an elevation lower than that of the first recess portion, a second detent member extended outwards from the front end of the body and opposite to the first detent member, and a second hole formed on the another lateral side of the body to communicate with the first housing and the second recess portion and formed at an elevation lower than that of the first hole; and
the pulley set includes a winding spool and a coil spring, the winding spool including a holding space in the center thereof, a second insertion hole at the bottom thereof run through by the holding strut of the body, and an upper holding trough and a lower holding trough on the periphery thereof, the coil spring being held in the holding space and including one end latched on a latch slot formed on an inner wall of the winding spool and another end latched on the slot of the holding strut.

3. The window covering of claim 2, wherein the first press assembly includes a first sleeve which includes a first wedge flange at one side thereof to wedge in the first recess portion of the body, two first apertures on two sides thereof corresponding to the first hole, two corresponding first ditches on an inner rim thereof, a first guide bar extended from an outer side of the first sleeve and adjacent to the first aperture to guide the second end of the first cord, and a first press member held inside thereof, the first press member including an outer end abutting the first detent member, two first bores on two sides thereof corresponding to the first apertures of the first sleeve, and two first bosses protruded from the two sides thereof and corresponding to the first ditches, a first elastic element being interposed between the first sleeve and the first press member.

4. The window covering of claim 3, wherein the second press assembly includes a second sleeve which includes a second wedge flange at one side thereof to wedge in the second recess portion of the body, two second apertures on two sides thereof corresponding to the second hole, two corresponding second ditches on an inner rim thereof, a second guide bar extended from at an outer side of the second sleeve and adjacent to the second aperture to guide the second end of the second cord, and a second press member held inside thereof, the second press member including an outer end abutting the second detent member, two second bores on two sides thereof corresponding to the second apertures of the second sleeve, and two second bosses protruded from the two sides thereof and corresponding to the second ditches, a second elastic element being interposed between the second sleeve and the second press member.

5. The window covering of claim 1, wherein the upper rail includes a first threading hole and a second threading hole penetrating through the bottom thereof and threaded through by the first cord and the second cord respectively for fastening on the upper rail.

6. The window covering of claim 5, wherein the lower rail includes a third threading hole and a fourth threading hole respectively corresponding to the first threading hole and the second threading hole and threaded through respectively by the first cord and the second cord.

7. The window covering of claim 6, wherein the lower rail includes a first roller assembly and a second roller assembly disposed at two sides of the cord winding assembly and corresponding to the third threading hole and the fourth threading hole to be wound by the first cord and the second cord respectively.

8. The window covering of claim 7, wherein the first roller assembly and the second roller assembly include respectively a first bracing seat and a second bracing seat, a first opening and a second opening on a top surface of the first bracing seat and the second bracing seat and corresponding to the third threading hole and the fourth threading hole, and a first guide rod and a second guide rod at one side of the first bracing seat and the second bracing seat and adjacent to the first opening and the second opening.
